(19) United States
(12) Patent Application Publication
(10) Pub. No.: US 2015/0198254 A1
(43) Pub. Date: Jul. 16, 2015

(54) DYNAMIC SEALING APPARATUS AND DYNAMIC SEALING SYSTEM THEREWITH

(71) Applicant: Shanghai Kimkey Environmental S&T Co., Ltd., Shanghai City (CN)

(72) Inventor: SHULEI DONG, Shanghai City (CN)

(73) Assignee: Shanghai Kimkey Environmental S&T Co., Ltd., Shanghai City (CN)

(21) Appl. No.: 14/194,727

(22) Filed: Mar. 1, 2014

(30) Foreign Application Priority Data
Jan. 13, 2014 (CN) 201410014801.3

(51) Int. Cl. F16J 15/52

(52) U.S. Cl. CPC F16J 15/52

(57) ABSTRACT

The present invention provides a dynamic sealing apparatus for sealing two relative move devices, the dynamic sealing apparatus includes a ripple pipe, a first conjunction and a second conjunction respectively arranged opposite ends of the ripple pipe and a compensated arm connected between the first conjunction and the second conjunction, the second conjunction is fixed with a first device, a second device is inserted in the ripple pipe through the first conjunction, and the compensated arm allows the first conjunction and the second conjunction to move relative in radical direction. The dynamic sealing apparatus includes the ripple pipe which can bend deformation, the first conjunction and the second conjunction can move relative in the radial direction, so as to compensate a radial offset efficiently between the dynamic device and the static device and to improve the sealing performance.

### BACKGROUND OF THE INVENTION

1. Field of the Invention

The present invention relates to mechanical sealing apparatus, and more particularly, to a dynamic sealing apparatus and dynamic sealing system therewith for sealing two relative move devices.

2. Background of the Invention

In many manufacturing industries, sealing performance is one of the most important characteristics and directly determines the technologic level of a mechanical device. As is known to all, static sealing is more common used for sealing the mechanical devices to ensure the sealing performance between two relative static components. Static sealing technology has been relatively mature.

At present, for a device needed to be moved in production process, it is often required to ensure the sealing performance between two relative move components of the device. The device generally requires high temperature heating. However, the thermal expansion factor may lead to an axis offset of the two relative move components, so that it is difficult to keep a relative position between the two relative move components. Obviously, the common used static sealing cannot meet the demand. As such, it is necessary to provide a dynamic apparatus to solve the existing problems.

### BRIEF SUMMARY OF THE INVENTION

An object of the present invention is to provide a dynamic sealing apparatus and dynamic sealing system therewith for sealing two relative move devices in which compensating a relative position offset of the two devices because of operating condition change, so as to ensure the sealing performance between the two devices.

The embodiment of the present invention provides the dynamic sealing apparatus for sealing a first device and a second device in relative move. The dynamic sealing apparatus includes a ripple pipe, a first conjunction and a second conjunction respectively arranged opposite ends of the ripple pipe, a compensated arm connected between the first conjunction and the second conjunction and a sealed assembly, wherein the second conjunction is fixed with the first device, the second device is inserted into the ripple pipe through the first conjunction, and the compensated arm allows the first conjunction and the second conjunction to relative move.

The sealed assembly includes a first gland fixed with the first conjunction, a sealed space configured to place a sealing material is formed between the first gland and an outer wall of the second device.

The sealed assembly further comprises a second gland fixed with the first gland, the second gland is arranged on a side of the first gland away from the ripple pipe, a first gap is between the first gland and the outer wall of the second device, a second gap is between the second gland and the outer wall of the second device, and the first gap is larger than the second gap.

The sealed assembly further comprises a second gland fixed with the first gland, the second gland is arranged on a side of the first gland away from the ripple pipe, a first gap is between the first gland and the outer wall of the second device, a second gap is between the second gland and the outer wall of the second device, and the first gap is larger than the second gap.

A circumferential groove configured to partially place the sealing material is formed at the outer wall of the second device, a location of the first gland is corresponding to the circumferential groove.

In one embodiment, the compensated arm at least comprises a first arm, a second arm and a rotary joint connected between the first arm and the second arm, extension directions of the first arm and the second arm are consistent.

In another embodiment, the compensated arm comprises a first arm, a second arm, a third arm, a first rotary joint connected between the first arm and the second arm and a second rotary joint connected between the second arm and the third arm, extension directions of the first arm, the second arm and the third arm are consistent.

The first device is a dynamic device, the second device is a static device, and the first conjunction, the second conjunction and the dynamic device rotate in the same angular velocity.

The embodiment of the present invention further provides a dynamic sealing apparatus for sealing a dynamic device and a static device. The dynamic sealing apparatus includes a ripple pipe; a first conjunction and a second conjunction respectively arranged opposite ends of the ripple pipe; a compensated arm connected between the first conjunction and the second conjunction; and a sealed assembly; wherein the sealed assembly comprises a sealed space and a sealing material placed in the sealed space, the sealed space is formed among at least a gland, a first conjunction and an outer wall of the static device, the gland is fixed with the first conjunction, the second conjunction is fixed with the dynamic device, the static device is inserted in the ripple pipe through the first conjunction, the compensated arm allows the first conjunction and the second conjunction to move relative and the first conjunction, the second conjunction and the dynamic device rotate in the same angular velocity.

The embodiment of the present invention further provides a dynamic sealing system. The dynamic sealing system includes a first device and a second device in relative movement; a dynamic sealing apparatus for sealing the first device and the second device, wherein the dynamic sealing apparatus comprises a ripple pipe, a first conjunction and a second conjunction respectively arranged opposite ends of the ripple pipe, and a compensated arm connected between the first conjunction and the second conjunction, wherein the second conjunction is fixed with the first device, the second device is inserted into the ripple pipe through the first conjunction, and the compensated arm allows the first conjunction and the second conjunction to relative move.

Compared with the prior art, the present invention provides the dynamic sealing apparatus for sealing relative move devices. The dynamic sealing apparatus includes the ripple pipe which can bend deformation, and the first conjunction and the second conjunction respectively arranged opposite ends of the ripple pipe, the first conjunction and the second conjunction can move relative in the radial direction, so as to compensate a radial offset efficiently between the dynamic device and the static device and to improve the sealing performance.

### BRIEF DESCRIPTION OF THE DRAWINGS

FIG. 1 is a schematic view of a dynamic sealing apparatus cooperated with a dynamic device and a static device of the present invention;

FIG. 2 is a structure schematic view of the dynamic sealing apparatus according to an embodiment of the present invention;

FIGS. 3A and 3B are each a cross-section view of the dynamic sealing apparatus according to an alternative embodiment of the present invention;

FIG. 4 is an assembled schematic view of the dynamic sealing apparatus filled with a sealing material according to an embodiment of the present invention;

FIG. 5 shows adjusting a distance between a first gland and a second gland of the dynamic sealing apparatus according to the embodiment of FIG. 4;

FIG. 6 is an assembled schematic view of the dynamic sealing apparatus filled with a sealing material according to another embodiment of the present invention.

### DETAILED DESCRIPTION OF THE PREFERRED EMBODIMENT

The features of this invention will now be described with reference to the drawings of preferred embodiments which are intended to illustrate and not to limit the invention.

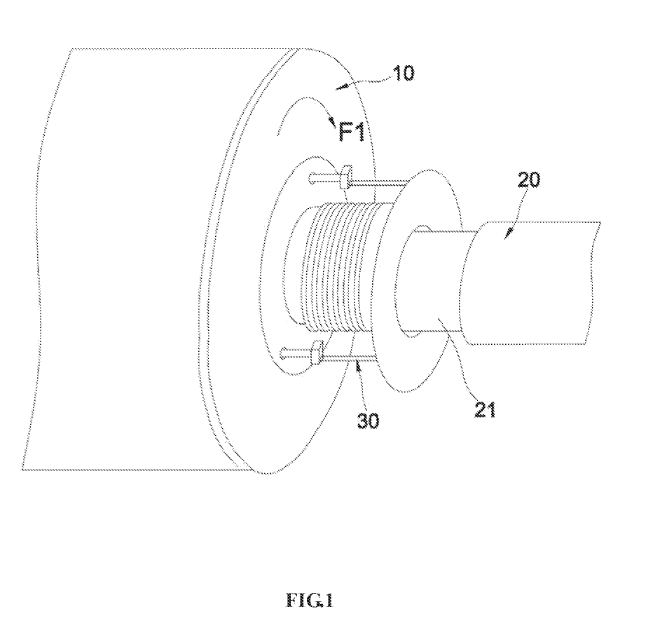

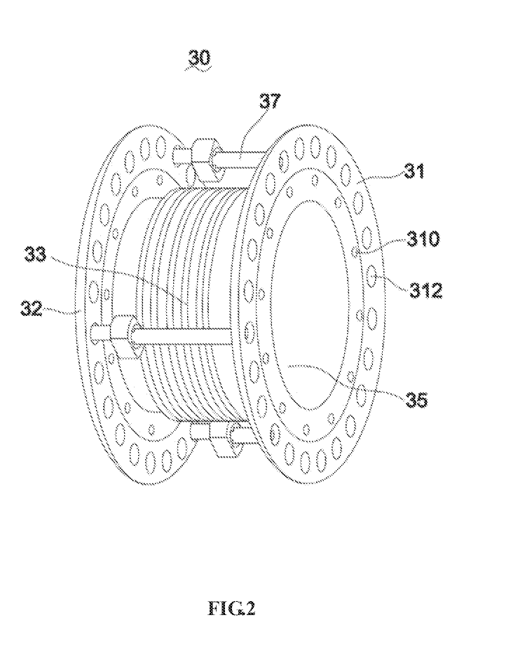

Referring to FIGS. 1 and 2, in an embodiment of the present invention, defining two relative move devices are a dynamic device 10 and a static device 20, wherein the dynamic device 10 rotates in a set speed along the direction of the F1. To seal the two relative move devices, the dynamic device 10 and the static device 20, a dynamic sealing apparatus 30 is connected therebetween. In the embodiment of the present invention, the dynamic sealing apparatus 30 includes a ripple pipe 33, a first conjunction 31 and a second conjunction 32 respectively arranged opposite ends of the ripple pipe 33, and a compensated arm 37 connected between the first conjunction 31 and the second conjunction 32. The second conjunction 32 is fixed with the dynamic device 10. The ripple pipe 33 includes a housing 35. An extended tube 21 from a side of the static device 20 inserted into the housing 35 of the ripple pipe 33 through the first conjunction 31. In the embodiment of the present invention, the first conjunction 31, the second conjunction 32 and the dynamic device 10 are in a linkage state, that is to say, the first conjunction 31 and the second conjunction 32 rotate in the same angular velocity. In various embodiments of the present invention, the first conjunction 31 and the second conjunction 32 can be set as the same axis or different axes, the same diameter or different diameters. In the present invention, it is important that the compensated arm 37 allows the first conjunction 31 and the second conjunction 32 to move relative in a radial direction, so as to compensate a radial offset between the dynamic device 10 and the static device 20 caused by thermal expansion and to ensure the sealing performance.

In the present invention, it is worth mentioning that if supposing the axis of the ripple pipe 33 is a first direction, the radial direction is interpreted as perpendicular to the first direction. When the dynamic device 10 and the static device 20 change under temperature, pressure and other operating conditions, it may cause an angular offset and an axial offset. The dynamic sealing apparatus 30 can also compensate the angular offset and the axial offset to ensure the sealing performance.

Continue to refer to FIG. 1, in other embodiments of the present invention, it is worth mentioned that the dynamic sealing apparatus 30 can also be applied to seal two devices while in move, but not relatively static. In other embodiments of the present invention, a device is inserted into the ripple pipe 33 through the first conjunction 31 may the dynamic device 10, and a device is fixed with the second conjunction 32 may be the static device 20.

Continue to refer to FIG. 2, in the embodiment of the present invention, the first conjunction 31 and the second conjunction 32 respectively includes a plurality of mounting holes 310, 312. The mounting holes 310 of the first conjunction 31 are configured to fix the dynamic sealing apparatus 30, the dynamic device 10 and the static device 20. The mounting holes 312 of the second conjunction 32 are configured to mount the compensated arm 37 between the first conjunction 31 and the second conjunction 32. In addition, the mounting holes 310, 312 also play the function of lightening the weight of components.

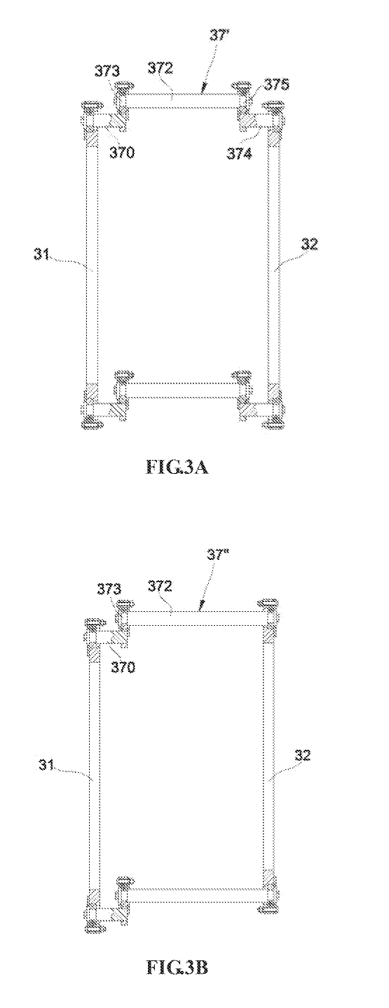

FIGS. 3A and 3B are each a cross-section view of the dynamic sealing apparatus according to the embodiments of the present invention. Referring to FIG. 3A, in an embodiment of the present invention, the compensated arm 37′ having compensation function includes a first arm 370, a second arm 372, a third arm 374, a first rotary joint 373 connected between the first arm 370 and the second arm 372, and a second rotary joint 375 connected between the second arm 372 and the third arm 374, wherein extension directions of the first arm 370, the second arm 372 and the third arm 374 are consistent. The second arm 372 can move relative around the first arm 370 and the third arm 374 because of the existence of the first rotary joint 373 and the second rotary joint 375. When the first conjunction 31 and the second conjunction 32 in a concentric rotating state occurs the axis offset caused by thermal expansion or pressure factor, the compensated arm between the first conjunction 31 and the second conjunction 32 make compensating movement adaptively with the axis offset. The relative movement of the dynamic device 10 and the static device 20 do not have any obstacle, and it always make sure the sealing performance between the dynamic device 10 and the static device 20.

Referring to FIG. 3B, comparing with the foregoing embodiments, in the embodiment of the present invention, a difference is that the compensated arm 37″ has a single rotary joint to achieve compensation function of the radial offset. In other embodiments of the present invention, it makes clear that the structure of the compensated arm and the number of the rotary joint are not limited to the disclosed embodiments.

In the present invention, for the second conjunction 32 connected with the dynamic device 10, there is no relative movement, so there is no sealing leakage problem. However, for the first conjunction 31 connected with the static device 20, there is always in a state of relative movement between the first conjunction 31 and the static device 20, so how to seal the first conjunction 31 and the static device 20 is particularly important.

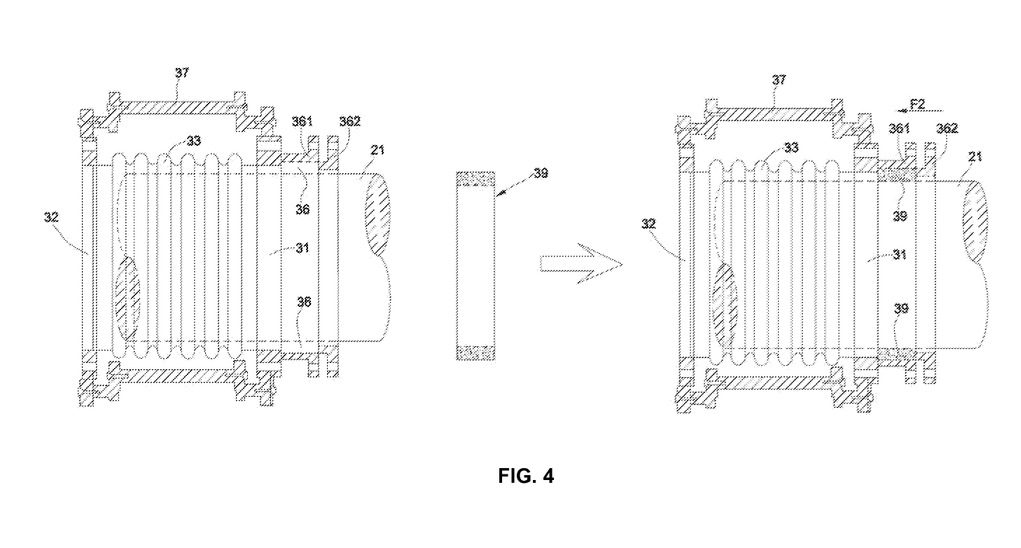

FIG. 4 is an assembled view of the dynamic sealing apparatus 30 filled with a sealing material according to an embodiment of the present invention. In the embodiment of the present invention, in order to solve the sealing problem of the first conjunction 31 side, the dynamic sealing apparatus 30 further includes a first gland 361 fixed with the first conjunction 31 and a second gland 362. The diameter of the first gland 361 and the second gland 362 is respectively larger than the diameter of the extended tube 21 of the static device 20 inserted in the ripple pipe 33. The second gland 362 is arranged on a side of the first gland 361 away from the ripple pipe 33. The first gland 361, the second gland 362 and the first conjunction 31 are in a linkage rotation state. When the first gland 361 and the second gland 362 are be peripheral sleeved on the extended tube 21 of the static device 20, the friction of first gland 361, the second gland 362 and the extended tube 21 of the static device 20 is small due to mutual gaps, thus reducing the driver motor load of the side of the dynamic device 10.

Continue to refer to FIG. 4, in the embodiment of the present invention, there is a first gap between the first gland 361 and an outer wall of the static device 20, and there is a second gap between the second gland 362 and the outer wall of the static device 20, wherein the first gap is larger than the second gap. A sealed space 36 configured to place a sealing material 39 is formed among the first gland 361, the second gland 362 and the outer wall of the static device 20. The sealed space 36 is a circumferential sealed space, and the volume of the sealed material 39 slightly larger than the volume of the sealed space 36 is placed in the sealed space 36. The sealing material 39 is annular strip and may be the industrial sealed packing.

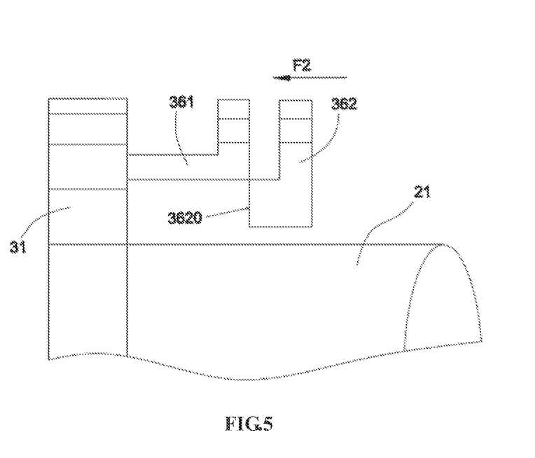

Referring to FIG. 5, the sealed packing 39 is easy to wear under long-term rotation operation, so that it cannot be completely filled with the sealed space 36 which leads to poor sealing. In order to avoid the problem, in a preferred embodiment of the present invention, the second gland 362 includes an extrusion surface 3620 facing the sealed space 36, and an adjustment mechanism (not shown) is set at a corresponding position of the first gland 360 and the second gland 362 to adjust a distance between the first gland 360 and the second gland 362. When the sealed packing 39 wear, it can close a distance between the first gland 360 and the second gland 362 by adjusting the adjustment mechanism. At this time, the extrusion surface 3620 moves closed to the sealed space 36 (F2 direction). Because the extrusion surface 3620 extrudes, the sealed packing 39 which is smaller because of wear can filled with the whole sealed space 36, so as to ensure the sealing performance.

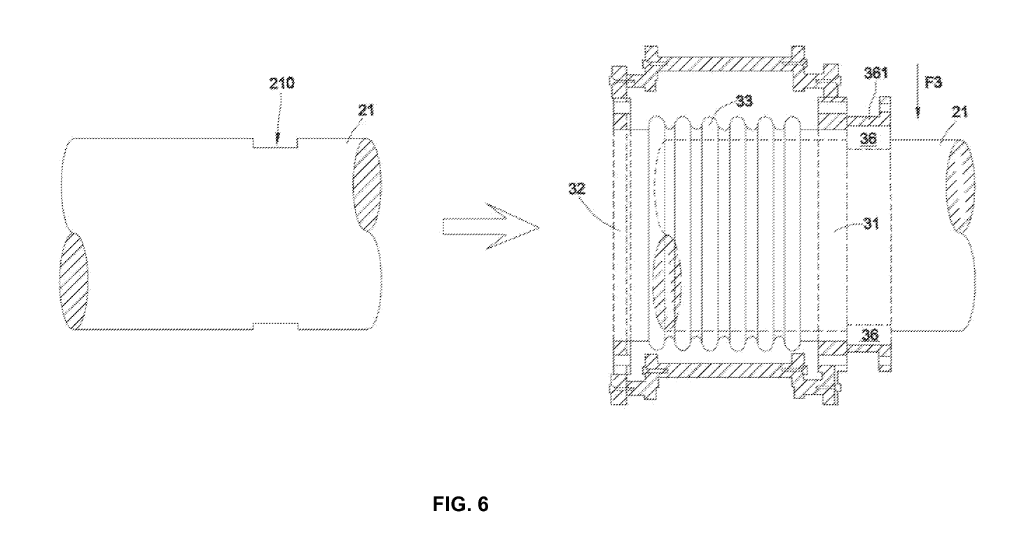

FIG. 6 is an assembled view of the sealing material in the dynamic sealing apparatus according to another embodiment of the present invention. Comparing with the foregoing embodiment, in the embodiment of the present invention, a difference is that there is no the second gland 362, meanwhile the outer wall of the extended tube 21 of the static device 20 has a circumferential groove 210. The extension directions of the circumferential groove 210 and the first gland 362 are consistent, that is to say, in the radial direction F3 of the extended tube 21 of the static device 20, the first gland 361 is always above the circumferential groove 210. After assembly, the first gland 361 and the circumferential groove 210 together form the sealed space 36. The sealed packing 39 is placed in the sealed space 36 and does not slide out from the sealed space 36.

In other embodiments of the present invention, it is worth mentioned that the first gland 361 and the second gland 362 does not need to set at the same time. If there is a circumferential gland, a block is set on a side of the circumferential gland which is away from the first conjunction 31 and the block extends toward to the extended tube 21 of the static device 20, so as to avoid the sealed packing 39 to slide out. Maybe the first gland 361 and the second gland 362 are integrally formed (regarded as the same circumferential gland). Above all, the dynamic sealing apparatus for sealing two relative move devices includes the ripple pipe 33 which can bend deformation, and the first conjunction 31 and the second conjunction 32 respectively arranged opposite ends of the ripple pipe 33. The first conjunction 31 and the second conjunction 32 can move relative in the radial direction, so as to compensate the radial offset efficiently between the dynamic device 10 and the static device 20 and to improve the sealing performance.

It should be understood that although the present specification is described in accordance with the embodiments, but not every embodiment contains only a single technical solution and the specification only for this narrative clarity. Those skilled persons in the art should regard the specification as a whole. The technical solutions of the embodiments can be appropriately combined to form other appreciated embodiments which the skilled person in the art can be understood.

The foregoing description is merely about exemplary embodiments of the present invention, but is not intended to limit the scope of the present invention. Any variation or replacement figured out by persons skilled in the art within the technical scope disclosed in the present invention shall fall within the protection of the present invention.

What is claimed is:

1. A dynamic sealing apparatus for sealing a first device and a second device in relative movement, comprising:
a ripple pipe;
a first conjunction and a second conjunction respectively arranged opposite ends of the ripple pipe; and
a compensated arm connected between the first conjunction and the second conjunction;
wherein the second conjunction is fixed with the first device, the second device is inserted into the ripple pipe through the first conjunction, and the compensated arm allows the first conjunction and the second conjunction to relative move.

2. The dynamic sealing apparatus according to claim 1, wherein the sealed assembly comprises a first gland fixed with the first conjunction, a sealed space configured to place a sealing material is formed between the first gland and an outer wall of the second device.

3. The dynamic sealing apparatus according to claim 2, wherein the sealed assembly further comprises a second gland fixed with the first gland, the second gland is arranged on a side of the first gland away from the ripple pipe, a first gap is between the first gland and the outer wall of the second device, a second gap is between the second gland and the outer wall of the second device, and the first gap is larger than the second gap.

4. The dynamic sealing apparatus according to claim 3, wherein the sealed assembly further comprises an adjustment mechanism configured to adjust a distance between the first gland and the second gland to compress volume of the sealed space.

5. The dynamic sealing apparatus according to claim 2, wherein a circumferential groove configured to partially place the sealing material is formed at the outer wall of the second device, a location of the first gland is corresponding to the circumferential groove.

6. The dynamic sealing apparatus according to claim 1, wherein the compensated arm at least comprises a first arm, a second arm and a rotary joint connected between the first arm and the second arm, extension directions of the first arm and the second arm are consistent.

7. The dynamic sealing apparatus according to claim 6, wherein the compensated arm comprises a first arm, a second arm, a third arm, a first rotary joint connected between the first arm and the second arm and a second rotary joint connected between the second arm and the third arm, extension directions of the first arm, the second arm and the third arm are consistent.

8. The dynamic sealing apparatus according to claim 1, wherein the first device is a dynamic device, the second device is a static device, and the first conjunction, the second conjunction and the dynamic device rotate in the same angular velocity.

9. The dynamic sealing apparatus according to claim 1, wherein the first device and the second device are while in move, but not relatively static.

10. A dynamic sealing apparatus for sealing a dynamic device and a static device, comprising:
a ripple pipe;
a first conjunction and a second conjunction respectively arranged opposite ends of the ripple pipe;
a compensated arm connected between the first conjunction and the second conjunction; and
a sealed assembly;
wherein the sealed assembly comprises a sealed space and a sealing material placed in the sealed space, the sealed space is formed among at least a gland, a first conjunction and an outer wall of the static device, the gland is fixed with the first conjunction, the second conjunction is fixed with the dynamic device, the static device is inserted in the ripple pipe through the first conjunction, the compensated arm allows the first conjunction and the second conjunction to move relative and the first conjunction, the second conjunction and the dynamic device rotate in the same angular velocity.

11. The dynamic sealing apparatus according to claim 10, wherein the at least a gland is a first gland, the sealed assembly further comprises a second gland fixed with the first gland, the second gland is arranged on a side of the first gland away from the ripple pipe, a first gap is between the first gland and the outer wall of the second device, a second gap is between the second gland and the outer wall of the second device, and the first gap is larger than the second gap.

12. The dynamic sealing apparatus according to claim 11, wherein the sealed assembly further comprises an adjustment mechanism configured to adjust a distance between the first gland and the second gland to compress volume of the sealed space.

13. The dynamic sealing apparatus according to claim 10, wherein the compensated arm at least comprises a first arm, a second arm and a rotary joint connected between the first arm and the second arm, extension directions of the first arm and the second arm are consistent.

14. The dynamic sealing apparatus according to claim 10, wherein the compensated arm comprises a first arm, a second arm, a third arm, a first rotary joint connected between the first arm and the second arm and a second rotary joint connected between the second arm and the third arm, extension directions of the first arm, the second arm and the third arm are consistent.

15. A dynamic sealing system, comprising:
a first device and a second device in relative movement; and
a dynamic sealing apparatus for sealing the first device and the second device, wherein the dynamic sealing apparatus comprises a ripple pipe, a first conjunction and a second conjunction respectively arranged opposite ends of the ripple pipe, and a compensated arm connected between the first conjunction and the second conjunction, wherein the second conjunction is fixed with the first device, the second device is inserted into the ripple pipe through the first conjunction, and the compensated arm allows the first conjunction and the second conjunction to relative move.

16. The dynamic sealing system according to claim 15, wherein the sealed assembly comprises a first gland fixed with the first conjunction, a sealed space configured to place a sealing material is formed between the first gland and an outer wall of the second device.

17. The dynamic sealing system according to claim 16, wherein the sealed assembly further comprises a second gland fixed with the first gland, the second gland is arranged on a side of the first gland away from the ripple pipe, a first gap is between the first gland and the outer wall of the second device, a second gap is between the second gland and the outer wall of the second device, and the first gap is larger than the second gap.

18. The dynamic sealing system according to claim 17, wherein the sealed assembly further comprises an adjustment mechanism configured to adjust a distance between the first gland and the second gland to compress volume of the sealed space.

19. The dynamic sealing system according to claim 15, wherein the compensated arm at least comprises a first arm, a second arm and a rotary joint connected between the first arm and the second arm, extension directions of the first arm and the second arm are consistent.

20. The dynamic sealing system according to claim 19, wherein the compensated arm comprises a first arm, a second arm, a third arm, a first rotary joint connected between the first arm and the second arm and a second rotary joint connected between the second arm and the third arm, extension directions of the first arm, the second arm and the third arm are consistent.
